(19) United States
(12) Patent Application Publication
(10) Pub. No.: US 2002/0152902 A1
(43) Pub. Date: Oct. 24, 2002

(54) Lacquering device

(76) Inventor: Volkmar Schwitzky, Wurzburg (DE)

Correspondence Address: Alison Kessler, Goodwin Procter LLP, Counsellors at Law, Seven Becker Farm Road, Roseland, NJ, 07068, US

(21) Appl. No.: 10/058,895

(22) Filed: Jan. 30, 2002

Related U.S. Application Data
(63) Continuation of application No. PCT/DE00/02329, filed on Jul. 15, 2000.

(30) Foreign Application Priority Data
Jul. 28, 1999 (DE) 199 35 171.6
Jul. 28, 1999 (DE) 199 35 172.4
Jul. 28, 1999 (DE) 199 35 173.2

(51) Int. Cl. B41F 23/08; B41F 9/01

(52) U.S. Cl. 101/153; 101/416.1

(57) ABSTRACT

The present invention relates to a lacquering device which is integrated in a printing machine or configured as a separate lacquering device. An object of the present invention is to provide a variable lacquering device for applying different lacquer thicknesses, lacquer types and/or lacquer colors in one lacquering device.

The invention relates to a lacquering device, which is integrated in a printing press or constructed as a separate lacquering machine.

A device for metering liquid media is known (DE 43 44 084 C1). It consists of a plate cylinder, which is assigned to an impression cylinder of a printing press, and a metering system, which is assigned to the plate cylinder and consists of an engraved ink transfer cylinder and a chamber doctor blade.

It is a disadvantage of this device that lacquer cannot be applied in different thicknesses or that partially different applications of lacquer cannot be produced.

It is an object of the invention to create a variable lacquering device for applying different thicknesses of lacquer, different types of lacquer, and/or different lacquer colors in one lacquering device.

Pursuant to the invention, this objective is accomplished by claims 1 and 6.

In the following, the invention is described in greater detail by an example and the drawings, in which

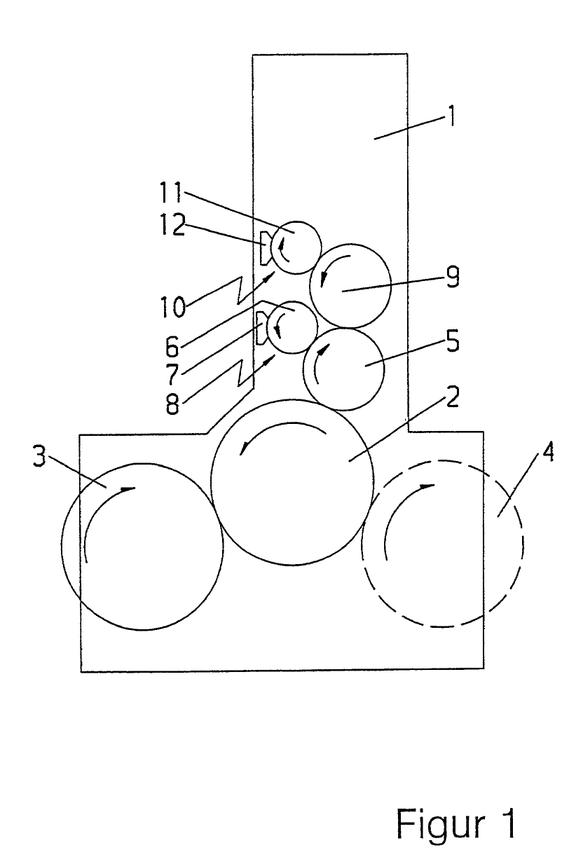

FIG. 1 shows a diagrammatic representation of a lacquering device with an additional metering system,

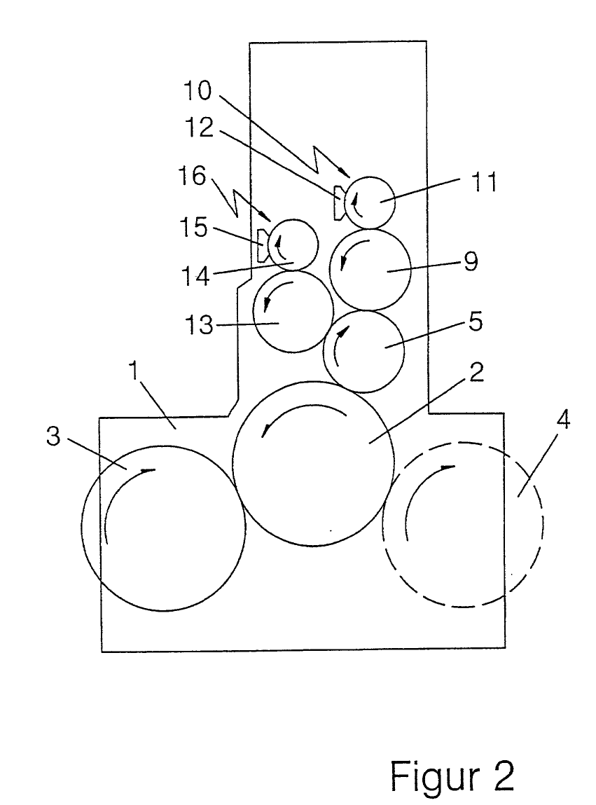

FIG. 2 shows a diagrammatic representation of a lacquering device with a metering system and an additional metering system and

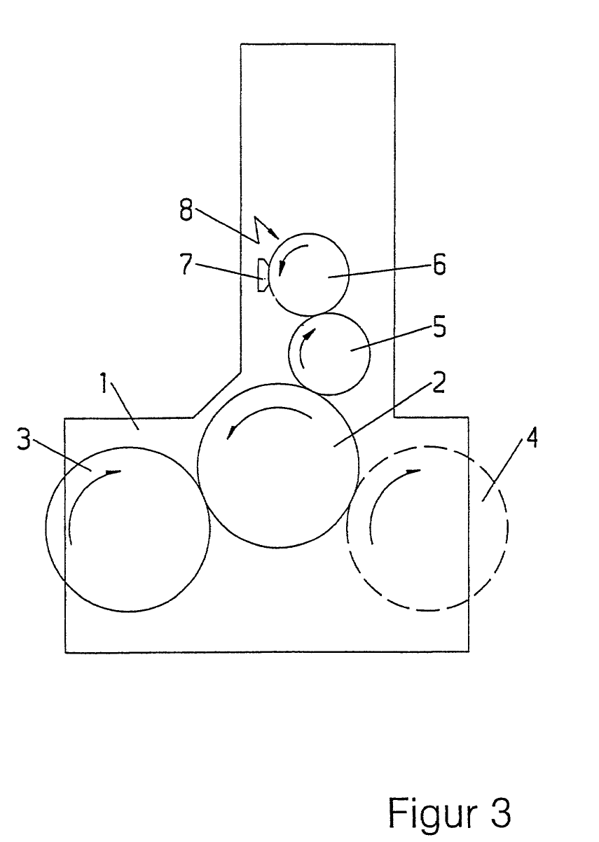

FIG. 3 shows a diagrammatic representation of a lacquering device with an engraved ink transfer cylinder and an applicator roll.

In the embodiment of the invention, shown in FIG. 1, the printing unit 1 of a printing press contains an impression cylinder 2 and a transfer drum 3 for guiding the sheet. A further transfer drum 4, shown by broken lines, of an upstream printing unit, which is not shown, is assigned to the impression cylinder 2. A subsequent printing unit can be disposed downstream from the transfer drum 3.

The impression cylinder 2 is connected with an application cylinder 5; a metering system 8, consisting of an engraved ink transfer cylinder and the chamber doctor blade 7, is assigned to the application cylinder 5. The ratio of the diameter of the application cylinder 5 to that of the impression cylinder 2 is 0.5 to 1. The impression cylinder carries two gripper systems (not shown) for transporting sheets.

An additional application cylinder 9 is disposed upstream from the application cylinder 5 and an additional metering system 10 consisting of an additional engraved ink transfer cylinder 11 and an additional chamber doctor blade 12 is assigned to the additional application cylinder 9.

According to a first variation, the application cylinder 5 and the additional application cylinder 9 are constructed as cylinders, covered with a rubber blanket.

For this variation, both rubber-covered cylinders are provided in the region of the printing size with lacquer over their whole surface, a thick, uniform layer of lacquer being applied on the sheet, which is guided by the impression cylinder.

According to a second variation, the application cylinder 5 is constructed as a cylinder, which is covered with a rubber blanket, and the additional application cylinder 9 is constructed as a lacquer plate cylinder, which is covered with a lacquer plate.

For this variation, the rubber-covered cylinder is provided over its whole surface and the lacquer plate cylinder partially, corresponding to the lacquer plate mounted, with lacquer. As a result, the sheet, guided on the impression cylinder, is coated over its whole surface with lacquer, the application being thicker in regions.

By these means, gloss effects or banknotes with intensified lacquering of the watermarks for a transparency effect are achieved.

According to a third variation, the application cylinder 5 and the additional application cylinder 9 are constructed as a lacquer plate cylinders, on which a lacquer plate is mounted.

For this variation, either the lacquer plates are the same size and in the same position and a thick, uniform application of lacquer corresponding to the lacquer plates is achieved or the lacquer plates are offset or differ in size and different amounts of lacquer are realized.

According to a fourth variation, the mounting or position of the plates of the application cylinder 5; 9 is the same or different and the processing of different lacquers (type of lacquer, viscosity, lacquer inking), for example, for packaging primers for adhesive joints and UV lacquer for external surfaces is possible.

When the lacquering device is used as a separate lacquering machine, a sheet feeding apparatus, which is not shown, precedes the lacquering device of the drawing and a taker-off, which is not shown, follows it.

In the embodiment of FIG. 2, the printing unit I of a printing press contains an impression cylinder 2 also for guiding sheets and a transfer drum 3. A further transfer drum 4 (shown by broken lines) of an upstream printing unit, which is not shown, is assigned to the impression cylinder 2. A subsequent printing unit, which is not shown, can be disposed downstream from the transfer drum 3.

The impression cylinder 2 is connected with an application cylinder 5. Over an additional application cylinder 13, a metering system 16, consisting of an engraved ink transfer cylinder 14 and a chamber doctor blade 15, is assigned to the application cylinder 5. Furthermore, over an additional application cylinder 9, an additional metering system 10, consisting of an additional engraved ink transfer cylinder 11 and an additional chamber doctor blade 12, is assigned to the application cylinder 5. The diameter ratios of application cylinder 5, additional application cylinder 13, additional application cylinder 9 and impression cylinder 2 are 0.5 to 1, the impression cylinder, for transporting sheets, having two gripper systems, which are not shown.

According to a first variation, the additional application cylinder 13 and the additional application cylinder 9 are constructed as cylinders, which are covered with a rubber blanket.

For this variation, both rubber-covered cylinders are provided with lacquer over their whole surface in the region of the printing size. As a result, a thick uniform coating of lacquer is applied over the application cylinder 5 on the sheet guided by the impression cylinder.

According to a second variation, the additional application cylinder 9 is constructed as a cylinder, which is covered with a rubber blanket, and the additional application cylinder 13 is constructed as a lacquer plate cylinder, which is covered with a lacquer plate. A reverse coverage is also possible For this variation, the rubber-covered cylinder is provided over its whole surface and the lacquer plate cylinder partially, corresponding to the lacquer plate mounted, with lacquer. As a result, the sheet, guided by the impression cylinder, is coated over its whole surface with lacquer by the application cylinder, the application being thicker in regions.

Gloss effects and banknotes with intensified lacquering of the watermarks for a transparency effect are produced.

According to a third variation, the additional application cylinder 13 and the additional application cylinder 9 are constructed as a lacquer plate cylinders, on which a lacquer plate is mounted. For this variation, either the lacquer plates are the same size and in the same position and a thick, uniform application of lacquer corresponding to the lacquer plates is achieved or the lacquer plates are offset or differ in size and different amounts of lacquer are applied.

According to a fourth variation, the mounting or position of the plates of the additional application cylinder 9; 13 is the same or different and the processing of different lacquers (type of lacquer, viscosity, lacquer inking), for example, for packaging primers for adhesive joints and UV lacquer for external surfaces is possible.

When the lacquering device is used as a separate lacquering machine, a sheet feeding apparatus, which is not shown, precedes the lacquering device of the drawing and a taker-off, which is not shown, follows it.

In the embodiment of FIG. 3, the devices of the printing press, for guiding the sheets, are disposed similarly to the above-mentioned embodiments.

The impression cylinder 2 is connected with an application cylinder 5; a metering system 8, consisting of an engraved ink transfer cylinder 6 and a chamber doctor blade 7, is assigned to the application cylinder 5.

The ratio of the diameter of the application cylinder 5 to that of the impression cylinder 2 is 1:2 and the diameter of the impression ink transfer cylinder 6 corresponds to that of the application cylinder 5.

The engraved ink transfer cylinder 6 is provided partially with different screenings, with which partially different amounts of lacquer (layer thicknesses) can be applied on the printed sheets.

This advantage is of benefit particularly for the following lacquering work:

sealing over the whole surface and, at the same time, emphasizing pictorial symbols by glossy lacquer (layer of great thickness)

visual effects by different degrees of gloss

sealing the complete surface of bank notes and, at the same time lacquering the watermark more heavily, in order to achieve a desired transparency.

When the lacquering device is used as a separate lacquering machine, a sheet feeding apparatus, which is not shown, precedes the lacquering device of the drawing and a taker-off, which is not shown, follows it.

What is claimed is:

1. A lacquering device with an application cylinder, which is connected with an impression cylinder, wherein a metering system (8), consisting of an engraved ink transfer cylinder (6) and a chamber doctor blade (7), is disposed ahead of the application cylinder (5) and/or at least one additional metering system (10; 16), consisting of an additional application cylinder (9; 13), an additional engraved ink transfer cylinder (11; 14) and an additional chamber doctor blade (12; 15), is disposed ahead of the application cylinder (5).

2. The lacquering device of claim 1, wherein two additional metering systems (10; 16), consisting of additional application cylinders (9; 13), additional engraved ink transfer cylinders (11, 14) and additional chamber doctor blades (12, 15), are disposed ahead of the application cylinder (5).

3. The lacquering device of claim 1 wherein the application cylinders are constructed as cylinders covered with a rubber blanket.

4. The lacquering device of claim 1 wherein one application cylinder (5 or 9) is constructed as a cylinder, covered with a rubber blanket and the other application cylinder (9 or 5) is constructed as a lacquer plate cylinder covered with a lacquer plate.

5. The lacquering device of claim 1, wherein the application cylinder (5, 9) is constructed as a lacquer plate cylinder, covered with a same or different lacquer plate.

6. A lacquering device with an application cylinder, which is connected with an impression cylinder and a metering system, which is assigned to the application cylinder and consists of an engraved ink transfer cylinder and a chamber doctor blade, wherein the diameter of the engraved ink transfer cylinder (6) is equal to the diameter of the application cylinder (5) and the engraved ink transfer cylinder (6) is provided with different screenings.
